(19) United States
(12) Patent Application Publication
(10) Pub. No.: US 2022/0268308 A1
(43) Pub. Date: Aug. 25, 2022

(54) QUICK-RELEASE CYMBAL LOCKING DEVICE

(71) Applicant: REMARKABLE Company, Taichung City (TW)

(72) Inventor: Ming Yi CHANG, Taichung City (TW)

(21) Appl. No.: 17/182,621

(22) Filed: Feb. 23, 2021

(51) Int. Cl. F16B 37/08; G10D 13/063

(52) U.S. Cl. CPC F16B 37/0857; G10D 13/063

(57) ABSTRACT

A quick-release cymbal locking device to be mounted to a stand rod includes a first locking member and a second locking member. The first locking member has an upper nut portion and a lower nut portion. A receiving space is defined between the upper and lower nut portions. The upper and lower nut portions each have a first through hole with a diameter greater than that of the stand rod. The first through hole includes a first threaded portion and a first smooth portion. The second locking member has a head portion and a handle portion. The head portion is inserted into the receiving space and has a second through hole with a diameter greater than that of the stand rod. The second through hole includes a second threaded portion and a second smooth portion.

### FIELD OF THE INVENTION

The present invention relates to a locking device for musical instruments, and more particularly to a quick-release cymbal locking device.

### BACKGROUND OF THE INVENTION

A cymbal needs to be mounted to a stand rod before use. A conventional cymbal stand is shown in FIG. 8. After a cymbal 71 is placed onto a stand rod 73, a wing nut 72 is screwed to the top of the stand rod 73, thereby locking the cymbal 71. After use, the wing nut 72 is unscrewed to remove it from the stand rod 73, and then the cymbal 71 is taken out. The assembly and disassembly of the wing nut 72 is time-consuming and labor-consuming, which causes inconvenience.

A conventional cymbal locking device, as disclosed in Chinese Patent No. CN101901594A, includes two movable locking members arranged oppositely. Each locking member is provided with a half-circle thread. The two locking members can be pushed to be closer to each other by a spring, so as to be secured onto the stand rod. When the cymbal locking device is to be removed, both sides of the two locking members are pressed to move the two locking members away from each other so as to disengage from the stand rod. However, the conventional structure uses the elastic force of the spring to push the two locking members to clamp the stand rod. When the spring is fatigued after a period of time, the locking members are unable to clamp the stand rod, so the cymbal cannot be locked. In addition, when the two locking members are pressed from both sides to move away from each other, a channel greater than the diameter of the stand rod is formed. Although the channel is conducive to pulling the stand rod out, it is based on the premise that the stand rod is pulled out straight, otherwise, if the stand rod is obliquely pulled out at an angle, the stand rod will be jammed in the channel and cannot be pulled out. This is inconvenient.

Another conventional cymbal locking device, as disclosed in Taiwan Utility Model Publication No. M435018, includes an immovable seat and a movable locking member. The movable locking member has a through hole with half-circle thread. The immovable seat is provided with a spring to push the movable locking member for the thread to hold the stand rod. However, the thread of the movable locking member only holds a part of the stand rod and does not completely surround the stand rod, which reduces the locking effect. Besides, when the spring is fatigued after a period of time, the locking member is unable to press against the stand rod. As a result, the locking member may loosen from the stand to generate noise when they collide with each other, which affects the sound performance of the musical instrument.

Accordingly, the inventor of the present invention has devoted himself based on his many years of practical experiences to solve these problems.

### SUMMARY OF THE INVENTION

The primary object of the present invention is to provide a quick-release cymbal locking device, which can be movably mounted to or dismounted from a cymbal stand. It has a better locking effect for assembly and an easy and smooth operation for disassembly.

A quick-release cymbal locking device to be mounted to a stand rod, comprising a first locking member and a second locking member. The first locking member has a body portion, an upper nut portion located on a top end of a first side face of the body portion, and a lower nut portion located on a bottom end of the first side face. A receiving space is defined between the upper nut portion and the lower nut portion. The upper nut portion and the lower nut portion each have a first through hole extending along a first axial direction. The first through hole has a diameter greater than that of the stand rod. The first through hole includes a first threaded portion away from the first side face and a first smooth portion close to the first side face. The second locking member has a head portion and a handle portion extending from a second side face of the head portion. The head portion is inserted into the receiving space and movable in a second axial direction perpendicular to the first axial direction. The head portion has a second through hole extending along the first axial direction. The second through hole has a diameter greater than that of the stand rod. The second through hole includes a second threaded portion away from the second side face and a second smooth portion close to the second side face. Wherein, the second locking member can be controlled to move away from the body portion for the first threaded portion and the second threaded portion to abut against the stand rod simultaneously. The second locking member can be controlled to be close to the body portion for the first threaded portion and the second threaded portion to leave the stand rod simultaneously and for the first smooth portion and the second smooth portion to abut against the stand rod simultaneously.

In an embodiment, the body portion has an accommodating room therein. The accommodating room extends along the second axial direction and communicates with the receiving space. A compression spring connected to the head portion of the second locking member is provided in the accommodating room. The second locking member is pushed by the compression spring and is normally away from the body portion.

In an embodiment, the body portion has an accommodating room therein. The accommodating room extends along the second axial direction and communicates with the receiving space. A tension spring connected to the handle portion of the second locking member is provided in the accommodating room. The second locking member is pulled by the tension spring and is normally away from the body portion.

Preferably, the quick-release cymbal locking device further comprises a casing. The casing covers the first locking member and the second locking member. The casing has an opening for the handle portion of the second locking member to be movably inserted therein.

In an embodiment, the quick-release cymbal locking device further comprises a casing that is integrally formed with the upper nut portion. The casing covers the first locking member and the second locking member. The casing has an opening for the handle portion of the second locking member to be movably inserted therein.

Preferably, a distance between a center of curvature of the first threaded portion and a center of curvature of the first smooth portion is greater than or equal to a depth of the first threaded portion. An inner diameter of the first smooth portion is greater than or equal to a maximum inner diameter of the first threaded portion. A distance between a center of curvature of the second threaded portion and a center of curvature of the second smooth portion is greater than or equal to a depth of the second threaded portion. An inner diameter of the second smooth portion is greater than or equal to a maximum inner diameter of the second threaded portion.

### BRIEF DESCRIPTION OF THE DRAWINGS

FIG. 1 is an exploded view in accordance with a first embodiment of the present invention;

FIG. 2 is a cross-sectional view in accordance with the first embodiment of the present invention;

FIG. 3 is a planar view of the first locking member and the second locking member in accordance with the first embodiment of the present invention;

FIG. 4 and FIG. 5 are schematic views in accordance with the first embodiment of the present invention when in use;

FIG. 6 is a cross-sectional view in accordance with a second embodiment of the present invention;

FIG. 7 is a cross-sectional view in accordance with a third embodiment of the present invention; and

FIG. 8 is a perspective view of a conventional cymbal locking device.

### DETAILED DESCRIPTION OF THE PREFERRED EMBODIMENTS

Embodiments of the present invention will now be described, by way of example only, with reference to the accompanying drawings.

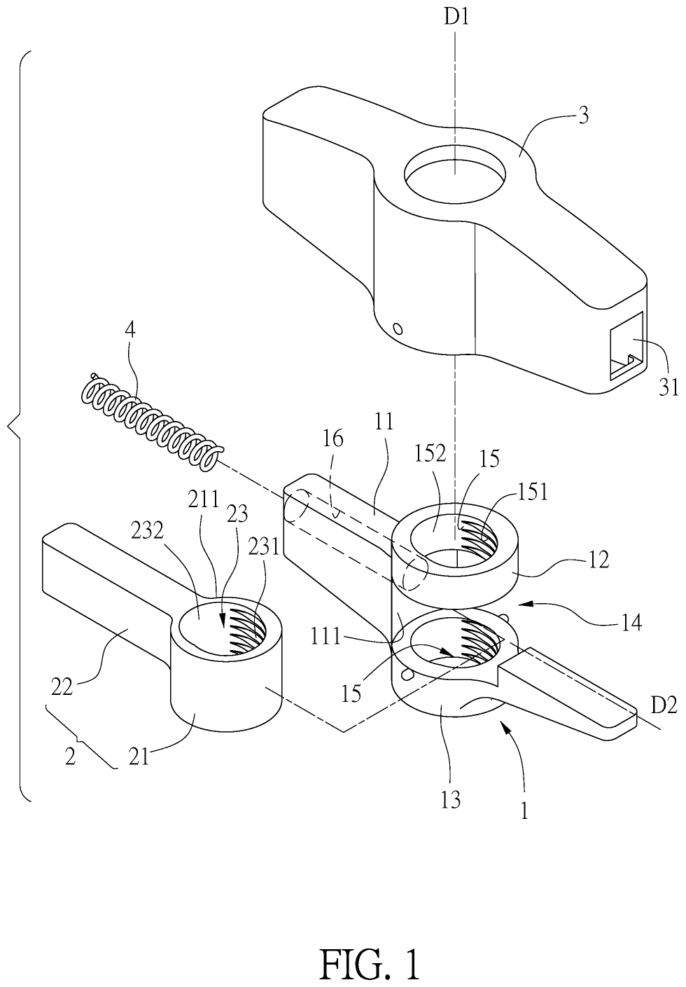

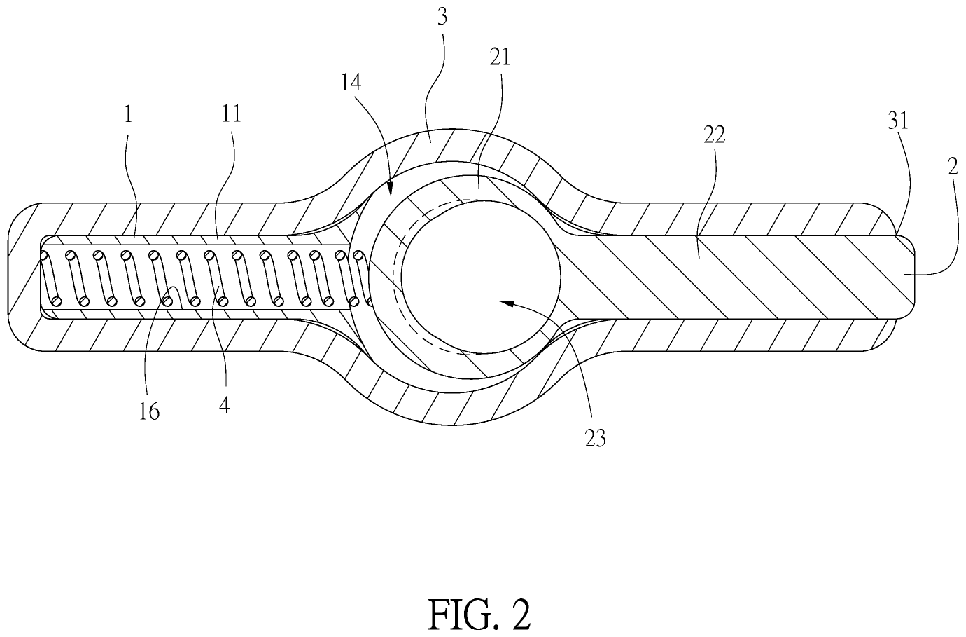

FIG. 1 and FIG. 2 show a first embodiment of a quick-release cymbal locking device provided by the present invention. The quick-release cymbal locking device is mounted to a stand rod configured to support a cymbal. The quick-release cymbal locking device comprises a first locking member 1, a movable second locking member 2, and a casing 3 configured to cover the first locking member 1 and the second locking member 2. The casing 3 has an opening 31 for the second locking member 2 to be movably inserted therein.

The first locking member 1 has a body portion 11. One side of the body portion 11 has a first side face 111. The top end of the first side face 111 extends laterally to form an upper nut portion 12. The bottom end of the first side face 111 extends laterally to form a lower nut portion 13. A receiving space 14 is defined between the upper nut portion 12 and the lower nut portion 13. A first axial direction D1 passing through the upper nut portion 12, the receiving space 14 and the lower nut portion 13 is defined. The upper nut portion 12 and the lower nut portion 13 each have a first through hole 15 extending along the first axial direction D 1. The diameter of the first through hole 15 is greater than the diameter of the stand rod.

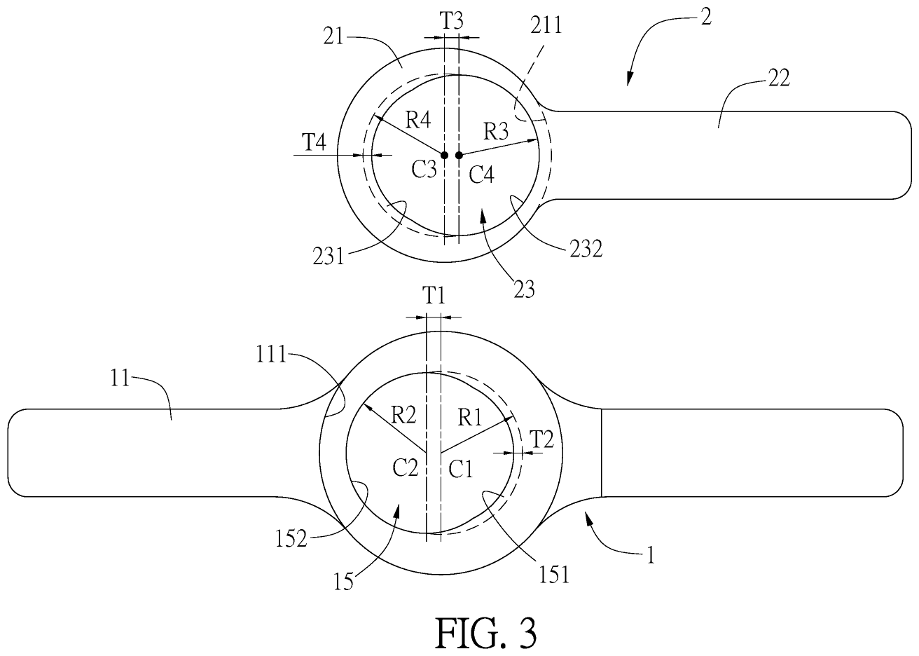

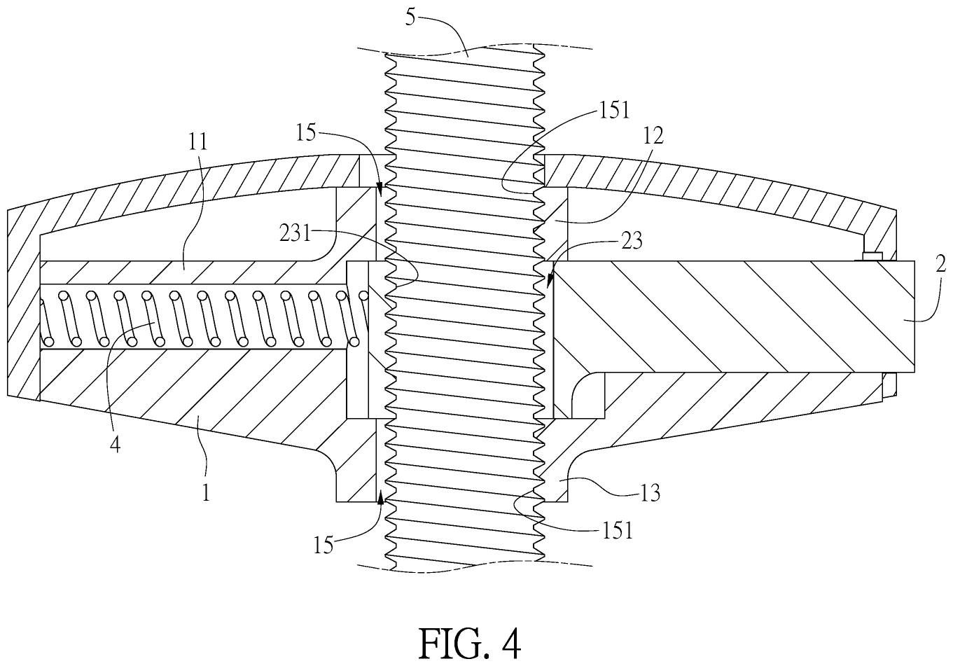

As shown in FIG. 3, the first through hole 15 is composed of a first threaded portion 151 and a first smooth portion 152. The first threaded portion 151 is located on a side away from the first side face 111, and the first smooth portion 152 is located on a side close to the first side face 111. The distance T1 between the center of curvature C1 of the first threaded portion 151 and the center of curvature C2 of the first smooth portion 152 is greater than or equal to the depth T2 of the first threaded portion 151. The inner diameter R2 of the first smooth portion 152 is greater than or equal to the maximum inner diameter R1 of the first threaded portion 151.

The second locking member 2 has a head portion 21. One side of the head portion 21 has a second side face 211. The second side face 211 extends laterally to form a handle portion 22. The handle portion 22 and the body portion 11 extend in opposite directions. The head portion 21 of the second locking member 2 is inserted into the receiving space 14, and is movable in a second axial direction D2 perpendicular to the first axial direction D1. The head portion 21 has a second through hole 23 extending along the first axial direction D1. The diameter of the second through hole 23 is greater than the diameter of the stand rod.

As shown in FIG. 3, the second through hole 23 is composed of a second threaded portion 231 and a second smooth portion 232. The second threaded portion 231 is located on a side away from the second side face 211, and the second smooth portion 232 is located on a side close to the second side face 211. The distance T3 between the center of curvature C3 of the second threaded portion 231 and the center of curvature C4 of the second smooth portion 232 is greater than or equal to the depth T4 of the second threaded portion 231. The inner diameter R3 of the second smooth portion 232 is greater than or equal to the maximum inner diameter R4 of the second threaded portion 231.

The body portion 11 of the first locking member 1 has an accommodating room 16. The accommodating room 16 extends along the second axial direction D2 and communicates with the receiving space 14. A compression spring 4 is provided in the accommodating room 16. One end of the compression spring 4 is pressed against the casing 3, and the other end of the compression spring 4 is pressed against the head portion 21 of the second locking member 2. The compression spring 4 normally pushes the head portion 21, so that the second locking member 2 receives a force away from the body portion 11.

With the above structure, when the quick-release cymbal locking device is to be mounted to a stand rod 5, the stand rod 5 passes through the first through hole 15 of the first locking member 1 and the second through hole 23 of the second locking member 2. As shown in FIG. 3, the second locking member 2 is pushed by the compression spring 4 to move in a direction away from the body portion 11, so that the second threaded portion 231 of the second through hole 23 tightly abuts against the stand rod 5. On the other hand, the stand rod 5 is pushed by the second locking member 2 to move in a direction away from the body portion 11, so that the stand rod 5 tightly abuts against the first threaded portion 151 of the first through hole 15. Accordingly, the stand rod 5 closely abuts against the first threaded portion 151 and the second threaded portions 231 simultaneously, so that the entire quick-release cymbal locking device is secured on the stand rod 5 for positioning the cymbal.

Due to the shape and size features of the first through hole 15 and the second through hole 23 as shown in FIG. 3, there is no need for the second locking member 2 to be pushed to the end of the stroke by the compression spring 4 (that is, the second threaded portion 231 tightly abuts against the stand rod 5). As long as it is pushed forward slightly for a part of the second threaded portion 231 to be in contact with the stand rod 5, so that the entire quick-release cymbal locking device can be secured on the stand rod 5. According to this, even if the compression spring 4 is fatigued after a period of time, it still allows the quick-release cymbal locking device to be locked on the stand rod 5.

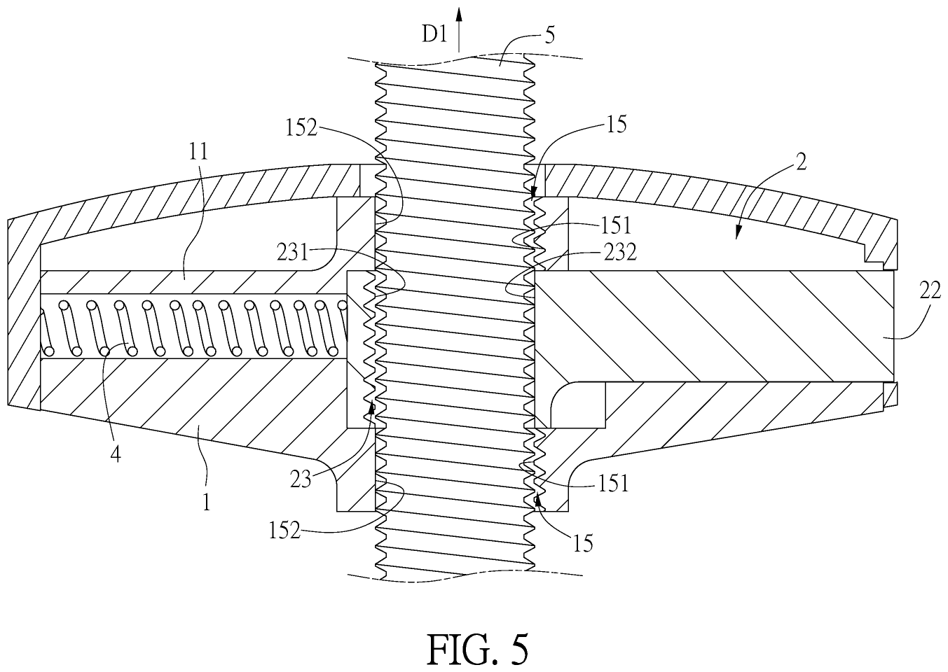

When the cymbal is to be picked up, as shown in FIG. 5, the user presses the handle portion 22 of the second locking member 2 to move the second locking member 2 toward the body portion 11, so that the second threaded portion 231 of the second through hole 23 leaves the stand rod 5 and the second smooth portion 232 abuts against the stand rod 5. On the other hand, the stand rod 5 is pushed by the second locking member 2 to move toward the body portion 11, so that the stand rod 5 leaves the first threaded portion 151 of the first through hole 15 and abuts against the first smooth portion 152. Thus, both the first threaded portion 151 and the second threaded portion 231 leave the stand rod 5 to release the locking, so that the entire quick-release cymbal locking device can be pulled out from the stand rod 5 and the cymbal can be removed.

When the second locking member 2 is pressed, the stand rod 5 further abuts against the first smooth portion 152 and the second smooth portions 232 simultaneously, which can ensure a smooth pull process. In addition, since both the first smooth portion 152 and the second smooth portion 232 are in contact with the stand rod 5 to form a limiting effect. Thus, the stand rod 5 can only be pulled in the same first axial direction D1 as the first through hole 15 and the second through hole 23, and will not be jammed when the pull direction is skewed.

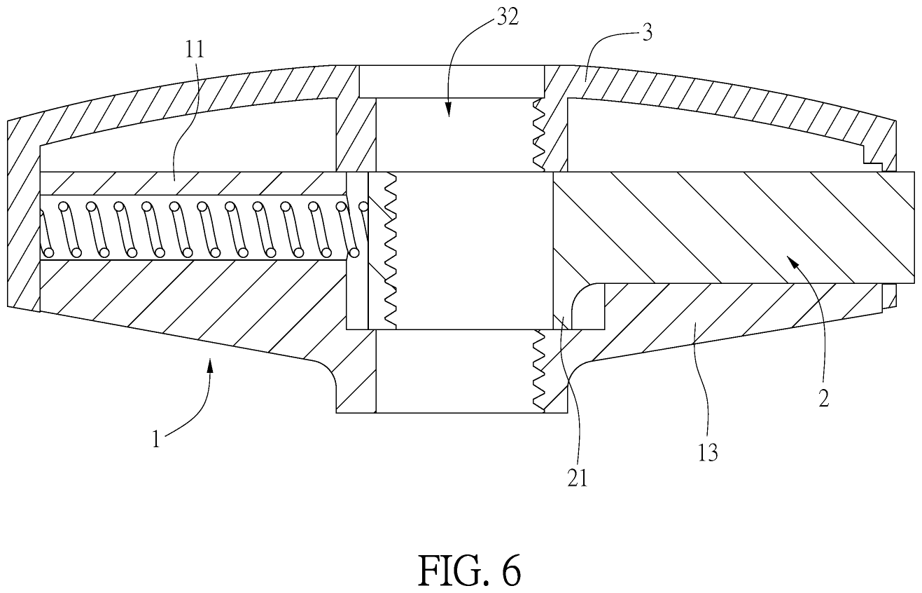

FIG. 6 shows a second embodiment of the present invention. The structure of the second embodiment is based on the structure of the first embodiment. The difference between the second embodiment and the first embodiment is that the casing is integrally formed with the upper nut portion. That is, the bottom end of the body portion 11 of the first locking member 1 extends laterally to form the lower nut portion 13. The head portion 21 of the second locking member 2 is arranged above the lower nut portion 13. The casing 3 covers the first locking member 1 and the second locking member 2, and has a third through hole 32. The structural feature of the third through hole 32 is the same as the first through hole. According to this structure, the second embodiment can also achieve the same function as the first embodiment.

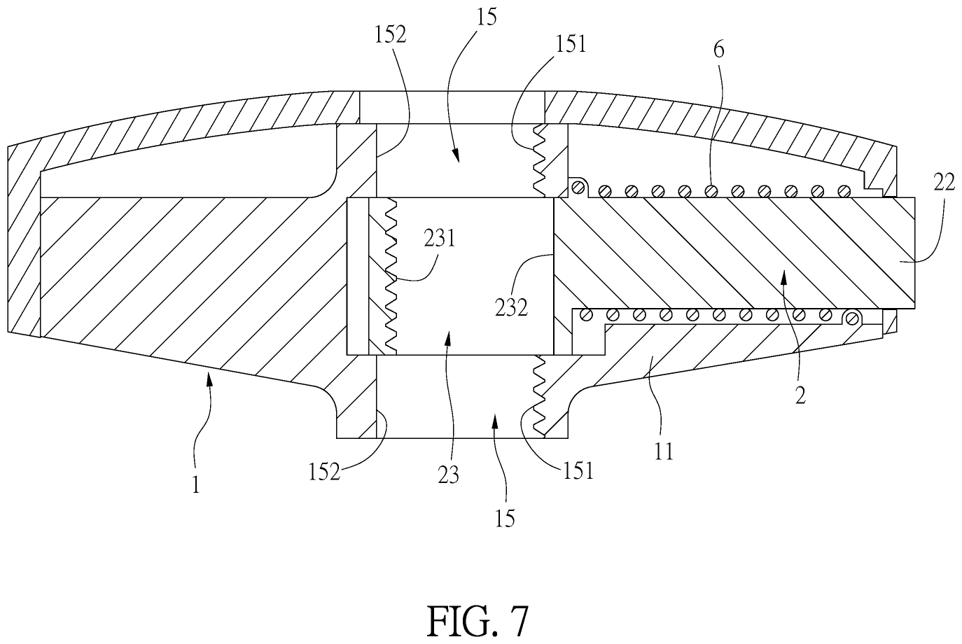

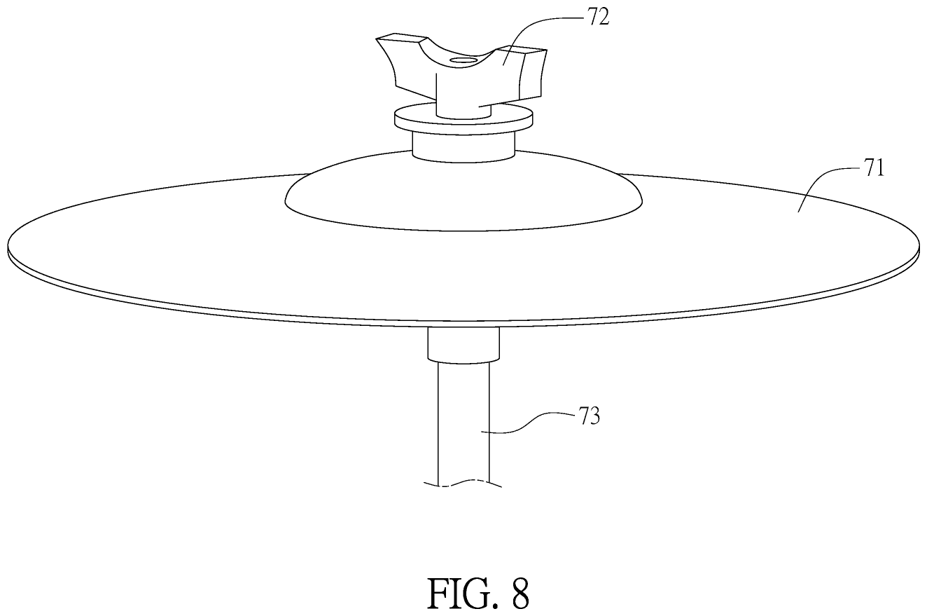

FIG. 7 shows a third embodiment of the present invention. The structure of the third embodiment is based on the structure of the first embodiment. The difference between the third embodiment and the first embodiment is that the second locking member 2 is controlled by a tension spring 6. One end of the tension spring 6 is connected to the body portion 11, and the other end of the tension spring 6 is connected to the handle portion 22 of the second locking member 2. Accordingly, the second locking member 2 is pulled by the tension spring 6 and normally moves in a direction away from the body portion 11, so that the second threaded portion 231 of the second through hole 23 is pressed against the stand rod. At the same time, the stand rod is pushed by the second locking member 2 to move away from the body portion 11, so that the stand rod is tightly pressed against the first threaded portion 151 of the first through hole 15. When the user presses the handle portion 22 of the second locking member 2 to move the second locking member 2 toward the body portion 11, so that the second threaded portion 231 of the second through hole 23 leaves the stand rod 5 and the second smooth portion 232 abuts against the stand rod 5. At the same time, the stand rod 5 is pushed by the second locking member 2 to move toward the body portion 11, so that the stand rod 5 leaves the first threaded portion 151 of the first through hole 15 and abuts against the first smooth portion 152 to release the locking, so that the cymbal can be removed.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A quick-release cymbal locking device to be mounted to a stand rod, comprising:
a first locking member, having a body portion, an upper nut portion located on a top end of a first side face of the body portion and a lower nut portion located on a bottom end of the first side face, a receiving space being defined between the upper nut portion and the lower nut portion, the upper nut portion and the lower nut portion each having a first through hole extending along a first axial direction, the first through hole having a diameter greater than that of the stand rod, the first through hole including a first threaded portion away from the first side face and a first smooth portion close to the first side face, a distance between a center of curvature of the first threaded portion and a center of curvature of the first smooth portion being greater than or equal to a depth of the first threaded portion, an inner diameter of the first smooth portion being greater than or equal to a maximum inner diameter of the first threaded portion;
a second locking member, having a head portion and a handle portion extending from a second side face of the head portion, the head portion being inserted into the receiving space and movable in a second axial direction perpendicular to the first axial direction, the head portion having a second through hole extending along the first axial direction, the second through hole having a diameter greater than that of the stand rod, the second through hole including a second threaded portion away from the second side face and a second smooth portion close to the second side face, a distance between a center of curvature of the second threaded portion and a center of curvature of the second smooth portion being greater than or equal to a depth of the second threaded portion, an inner diameter of the second smooth portion being greater than or equal to a maximum inner diameter of the second threaded portion;
wherein the second locking member can be controlled to move away from the body portion for the first threaded portion and the second threaded portion to abut against the stand rod simultaneously; the second locking member can be controlled to be close to the body portion for the first threaded portion and the second threaded portion to leave the stand rod simultaneously and for the first smooth portion and the second smooth portion to abut against the stand rod simultaneously.

2. The quick-release cymbal locking device as claimed in claim 1, wherein the body portion has an accommodating room therein, the accommodating room extends along the second axial direction and communicates with the receiving space, a compression spring connected to the head portion of the second locking member is provided in the accommodating room, and the second locking member is pushed by the compression spring and is normally away from the body portion.

3. The quick-release cymbal locking device as claimed in claim 1, wherein the body portion has an accommodating room therein, the accommodating room extends along the second axial direction and communicates with the receiving space, a tension spring connected to the handle portion of the second locking member is provided in the accommodating room, and the second locking member is pulled by the tension spring and is normally away from the body portion.

4. The quick-release cymbal locking device as claimed in claim 1, further comprising a casing, the casing covering the first locking member and the second locking member, the casing having an opening for the handle portion of the second locking member to be movably inserted therein.

5. The quick-release cymbal locking device as claimed in claim 1, further comprising a casing that is integrally formed with the upper nut portion, the casing covering the first locking member and the second locking member, the casing having an opening for the handle portion of the second locking member to be movably inserted therein.
